(19) United States
(12) Patent Application Publication
(10) Pub. No.: US 2026/0338998 A1
(43) Pub. Date: Oct. 29, 2026

(54) TUNABLE LENS COMPRISING PASSIVE THERMAL COMPENSATION MEANS

(71) Applicant: poLight ASA, Tønsberg (NO)

(72) Inventors: Janne Tapani Kilpinen, Akaa (FI); Pierre Craen, Embourg (BE)

(21) Appl. No.: 19/484,839

(22) PCT Filed: Jun. 27, 2024
(86) PCT No.: PCT/EP2024/068126

§ 371 Date: Nov. 14, 2025

(30) Foreign Application Priority Data
Jun. 30, 2023 (EP) 23182812.0
Sep. 29, 2023 (EP) 23200732.8

(51) Int. Cl. G02B 3/14

(52) U.S. Cl. CPC G02B 3/14

(57) ABSTRACT

A tunable lens comprising passive thermal compensation means.

### FIELD OF THE INVENTION

The present invention relates to a tunable lens comprising means for creating a predetermined thermal optical power variation and a method for creating a predetermined thermal optical power variation.

### BACKGROUND OF THE INVENTION

The phenomenon of focus drift in optical systems due to temperature variations is widely recognized, and it imposes limitations on the temperature range in which a device can operate effectively according to its specifications.

In general, lens systems require meticulous design or the use of actuators to adjust the lens's focus in order to maintain stable optical performance within a specific temperature range.

Due to different coefficient of thermal expansion (CTE) of the materials used in the different elements of the tunable lens structure, deformation of the optical portion of the tunable lens may occur.

In that, there is a need for simple solutions compensating the effects of temperature drift, without the use of actuators.

A lens system that could be incorporated into an optical stack that compensates for the thermal defocus caused by the stack itself would be advantageous as it would majorly simplify the design process.

Hence, there is a need for lens system configuration creating thermal optical compensation for lens stack.

### OBJECT OF THE INVENTION

The primary objective of the present invention is to offer a tunable lens that possesses the capability to counterbalance thermal defocus.

Additionally, an objective of the present invention can be viewed as providing an alternative solution to the existing prior art.

Specifically, an objective of the present invention is to supply a tunable lens with the ability to compensate for thermal defocus, thereby resolving the previously mentioned issues encountered in the prior art, by employing means creating a predetermined thermal optical power variation of the tunable lens.

### SUMMARY OF THE INVENTION

Thus, the above-described object and several other objects are intended to be obtained in a first aspect of the invention by providing a tunable lens, comprising: a first and a second transparent membrane; a transparent, deformable, non-fluid body located in between the first and the second transparent membrane, the transparent, deformable, non-fluid body comprises a polymer; means for creating a predetermined thermal optical power variation of the tunable lens, thereby compensating thermal defocus without the presence of active compensation means, such as actuators.

The invention rely on means for creating a predetermined thermal optical power variation, i.e. uses the non-fluid body and the transparent membrane thermal expansion properties or external elements such as coatings, structural elements or rigid structures to create optical power.

In that means for creating a predetermined thermal optical power variation may also be seen as means for controlling thermal expansion of the tunable lens.

The invention introduces a practical arrangement for constructing a thermal optical compensator for a lens stack as a passive way of compensating thermal drift in a lens stack, thereby without the use of active compensations means, such as actuators.

This passive compensator tunable lens, in absence of actuation means, may comprise at least one transparent membrane that may undergo deformation due to thermal effects in contact with a non-fluid body comprising an optically transparent polymer and means for creating a predetermined thermal optical power variation which can effectively mitigate thermal variations within the system.

The means for creating a predetermined thermal optical power variation of the tunable lens allow for creating a predetermined thermal optical power variation of the tunable lens in a range between +/−5 diopters, such as between +/−1 or +/−3 diopters, within a temperature range or within a thermal variation between −40 to 120 °C.

The means for creating a predetermined thermal optical power variation allows for controlling thermal expansion of said tunable lens optical power in a range between +/−5 diopters within a temperature range between −40 to 120 °C.

The variation of optical power may be between +/−5 diopters as the thermal compensation may be designed for negative or positive thermal expansions or for both.

The material of the first and a second transparent membrane may include glass, polymer, or crystal, as long as it exhibits sufficient transparency within the desired wavelength range of the system.

The non-fluid body comprises a polymer that may be a polymer network of cross-linked or partly cross-linked polymers comprising a miscible oil or combination of oils.

Thickness, volume and stiffness of the polymer network, as well as its CTE, may be tuned to achieve the creation of the predetermined thermal optical power variation desired.

The polymer network may have a CTE up to 10 times bigger than the one of the first and a second transparent membrane.

The means for creating a predetermined thermal optical power variation may comprise at least one coating located onto at least part of the first and/or the second transparent membrane.

The at least one coating has different CTE than the one of the first and/or the second transparent membrane.

The at least one coating could be located on either side of the first and/or the second transparent membrane. In some embodiments, the at least one coating may cover the first and/or the second transparent membrane only partly, e.g. in pattern to control the thermal deformation.

The at least one coating may be a film of an optical transparent material having a different CTE than the one of the first and the second transparent membrane.

The presence of the at least one coating is a film of an optical transparent material having a different CTE than the one of the first and the second transparent membrane will cause a bending of the first or the second transparent membrane over a temperature variation, depending on the geometry of the coating.

Optical power variation may be achieved in one or more dimension.

For example, the tunable lens may be a cylindrically tunable lens.

The at least one coating may has a transparency gradient along the radius of the tunable lens, i.e. it could be transparent over the aperture of the lens and non-transparent outside the aperture, wherein transparency is defined as a degree of transmittance higher than 50% along the VIS spectrum.

In some embodiments, the means for creating a predetermined thermal optical power variation of the tunable lens comprises at least one structural element, such as a circular element, located onto, below or within the first and/or the second membrane.

The structural element may have a different CTE than the one of the first and/or the second transparent membrane.

The structural element may not be circular, for example in case of cylindrical tunable lens.

The structural element may be mounted in different areas of the one of the first and/or the second transparent membrane, e.g. top or bottom side of the one of the first and/or the second transparent membrane.

In some other embodiments the means for creating a predetermined thermal optical power variation of the tunable lens comprises a rigid structure located between the first and the second transparent membrane.

The rigid structure may be positioned between the two transparent membranes, allowing for adjustable focusing capabilities. For instance, a tunable lens may be designed utilizing a fixed frame sandwiched between two flexible layers of transparent material. Thermal expansion applying different levels of pressure or tension to the membranes will produce a change on its focal length, enabling focusing on objects at varying distances.

In some embodiments, the second transparent membrane is a stiff substrate.

In some other embodiments, the first and/or second transparent membrane is a plano-convex or plano-concave membrane.

For example, the first and/or second transparent membrane may have a thickness gradient along a radius of the tunable lens.

In another aspect, the invention relates to a projector or a sensor, such as an image sensor, comprising a tunable lens according to the first aspect of the invention.

In a second aspect, the invention relates to a method for creating a predetermined thermal optical power variation of a tunable lens according to any of the preceding claims, the method comprising:
depositing transparent, deformable, non-fluid body onto the first or the second transparent membrane;
providing means for creating a predetermined thermal optical power variation by coating the first and/or the second transparent membrane with an optical transparent material having a different CTE than the one of the first and the second transparent membrane or by applying at least one structural element, such as a circular element, onto, below or within the first and/or the second membrane, the at least one structural element having a different CTE than the one of the first and the second transparent membrane.

In a further aspect, the invention relates to a method for creating a predetermined thermal optical power variation of a tunable lens, the tunable lens comprising a first and a second transparent membrane, a transparent, deformable, non-fluid body located in between said first and said second transparent membrane, the method comprising:
depositing transparent, deformable, non-fluid body onto said first or said second transparent membrane;
providing means for creating a predetermined thermal optical power variation by coating the first and/or the second transparent membrane with an optical transparent material having a different CTE than the one of the first and the second transparent membrane or by applying at least one structural element, such as a circular element, onto, below or within the first and/or said second membrane, the at least one structural element having a different CTE than the one of the first and said second transparent membrane.

The first, second and other aspects and embodiments of the present invention may each be combined with any of the other aspects and embodiments. These and other aspects of the invention will be apparent from and elucidated with reference to the embodiments described hereinafter.

### BRIEF DESCRIPTION OF THE FIGURES

The tunable lens and the method of the invention will now be described in more details with regard to the accompanying figures. The figures show one way of implementing the present invention and are not to be construed as being limiting to other possible embodiments falling within the scope of the attached claim set.

FIGS. 1 to 8 show cross sections view of different tunable lens according to some embodiments of the invention.

FIGS. 9 and 10 show a flow diagram of the methods according to some embodiments of the invention.

### DETAILED DESCRIPTION OF AN EMBODIMENT

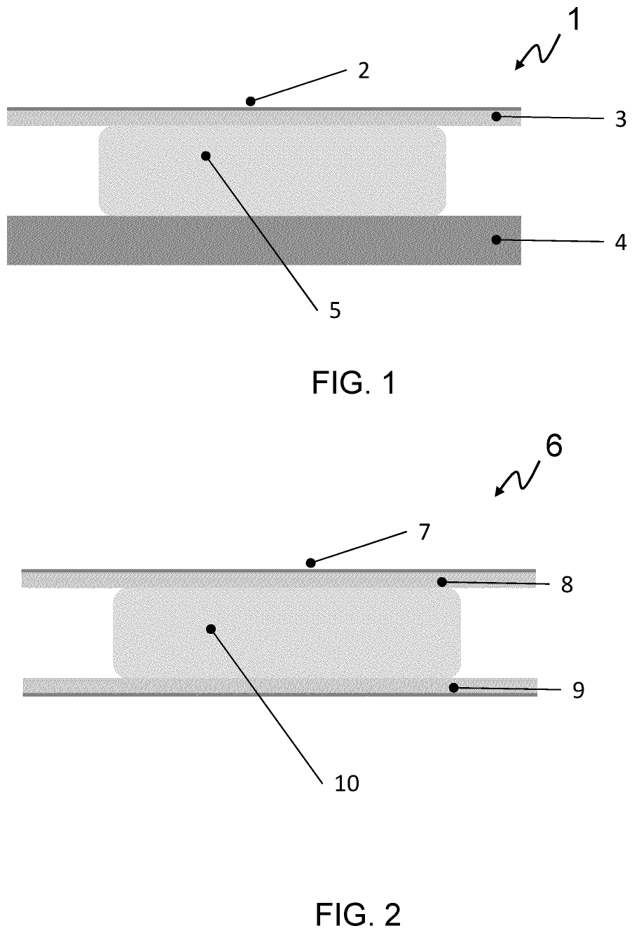

FIG. 1 shows a cross sections view of a tunable lens according to some embodiments of the invention in which the means for creating a predetermined thermal optical power variation is a coating.

The tunable lens of FIG. 1 comprises a lens body sandwiched between one deformable transparent membrane, one rigid or deformable transparent membrane, i.e. a membrane that may have a certain degree of stiffness.

One of the membrane is coated with a coating having a different CTE than that of the membrane.

The coating could be on either side of the membrane, and be deposited only on part of the membrane, e.g. only on the inside or on the outside of the aperture, or in a specific pattern so as to control the thermal deformation.

A certain degree of transparency will be required over the aperture. However, outside the aperture transparency is not a requirement

FIG. 2 shows a cross sections view of a tunable lens comprising a coating as in FIG. 1.

The tunable lens of FIG. 2 comprises a lens body sandwiched between two deformable transparent membranes.

One of the membrane is coated with a coating having a different CTE than that of the membrane.

The coating could be on either side of the membrane, and be deposited only on part of the membrane, e.g. only on the inside or on the outside of the aperture, or in a specific pattern so as to control the thermal deformation.

A certain degree of transparency will be required over the aperture. However, outside the aperture transparency is not a requirement

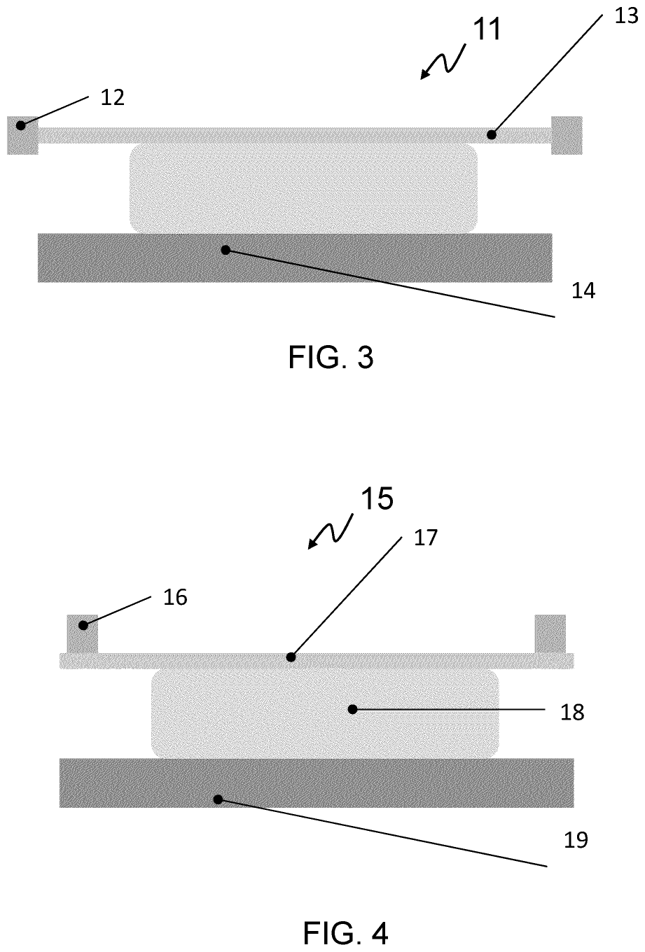

FIGS. 3-5 show a cross sections view of tunable lens according to some embodiments of the invention in which the means for creating a predetermined thermal optical power variation is structural element, i.e. a circular element surrounding the lens aperture.

The circular element has different CTE than the one of the membranes.

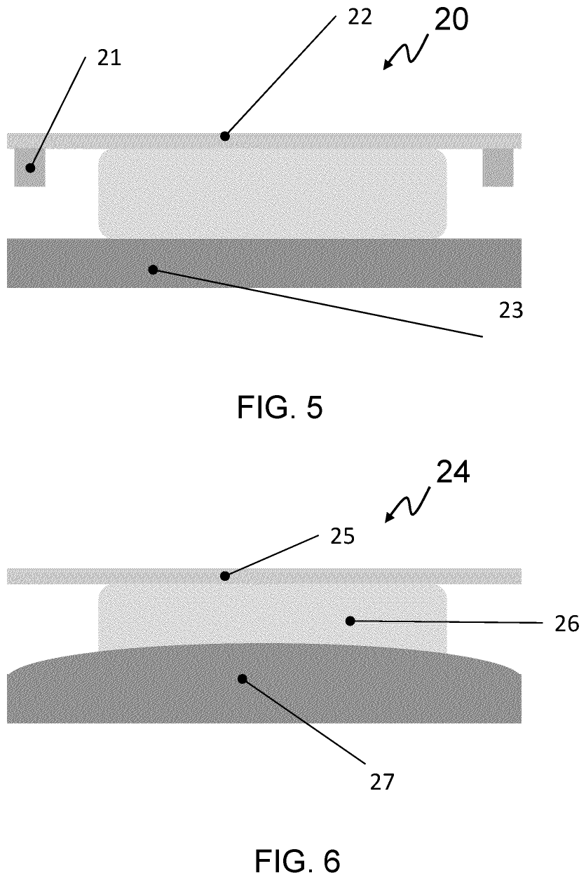

The circular element may be mounted on the outside, i.e. FIG. 4, or on the inside, i.e. FIG. 5, of one of the deformable membranes.

FIG. 3 shows a lens body sandwiched between one deformable transparent membrane and one rigid or deformable transparent membrane in which the circular element is at the edge of the deformable transparent membrane.

FIGS. 3-5 show solution in which a lens body sandwiched between one deformable transparent membrane and one rigid transparent membrane. However, similar solutions could be produced having a lens body sandwiched between two deformable transparent membranes.

FIG. 6 shows a lens body sandwiched between one deformable transparent membrane and one rigid transparent membrane in which the rigid transparent membrane has radial degree of thickness, i.e. the rigid transparent membrane is a plano-convex membrane.

Temperature variation producing lens body expansion will induce deformation of the deformable transparent membrane and thus change the optical power of a lens stack.

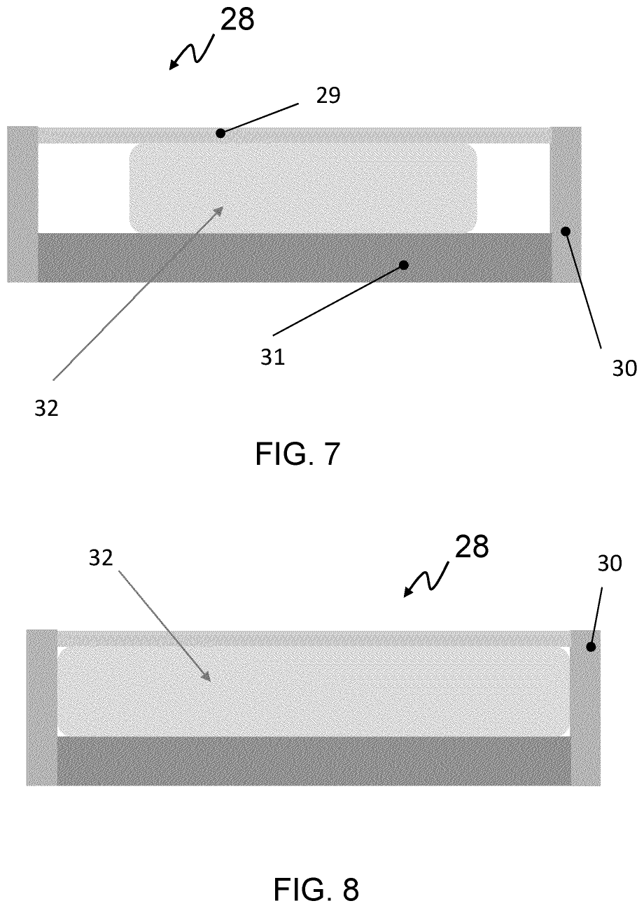

FIGS. 7-8 show a cross sections view of tunable lens according to some embodiments of the invention in which the means for creating a predetermined thermal optical power variation is a rigid structure.

The rigid structure has a different CTE than the one of the lens body.

In some embodiments, the lens body fill the entire volume of between the membranes as shown in FIG. 8.

In some other embodiments, the lens body does not tough the side walls of the rigid structure, as shown in FIG. 7.

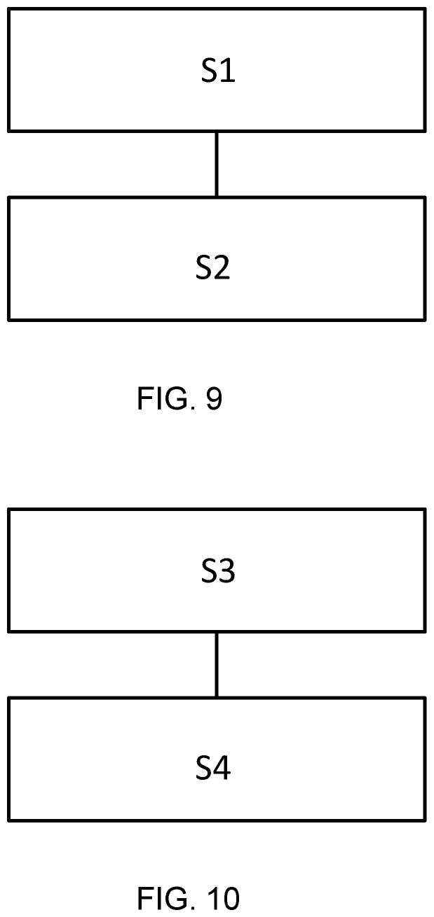

FIGS. 9 and 10 show a flow diagram of the methods according to some embodiments of the invention.

FIG. 9 discloses a method for creating a predetermined thermal optical power variation of a tunable lens comprising the steps of:
(S1) depositing transparent, deformable, non-fluid body onto the first or the second transparent membrane;
(S2) providing means for creating a predetermined thermal optical power variation by coating the first and/or the second transparent membrane with an optical transparent material having a different CTE than the one of the first and the second transparent membrane or by applying at least one structural element, such as a circular element, onto, below or within the first and/or the second membrane, the at least one structural element having a different CTE than the one of the first and the second transparent membrane.

FIG. 10 discloses a method for creating a predetermined thermal optical power variation of a tunable lens comprising a first and a second transparent membrane, a transparent, deformable, non-fluid body located in between the first and the second transparent membrane, the method comprising the steps of:
(S3) depositing transparent, deformable, non-fluid body onto the first or the second transparent membrane;
(S4) providing means for creating a predetermined thermal optical power variation by coating the first and/or the second transparent membrane with an optical transparent material having a different CTE than the one of the first and the second transparent membrane or by applying at least one structural element, such as a circular element, onto, below or within the first and/or the second membrane, the at least one structural element having a different CTE than the one of the first and the second transparent membrane.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A method for creating a predetermined thermal optical power variation for a tunable lens, which comprises:
a first deformable and a second deformable transparent membrane;
a transparent, deformable, non-fluid body located in between said first deformable and said second deformable transparent membrane, said transparent, deformable, non-fluid body comprising a polymer;
a structure located between said first deformable and said second deformable transparent membrane, which induces a predetermined thermal optical power variation of said tunable lens in a range between +5 diopters and −5 diopters, within a temperature range between −40 to 120 °C, and wherein said polymer is a polymer network of cross-linked or partly cross-linked polymers comprising a miscible oil or combination of oils, thereby compensating thermal defocus without actuators
said method comprising:
depositing the transparent, deformable, non-fluid body onto said first deformable or said second deformable transparent membrane;
providing the structure located between said first deformable and said second deformable transparent membrane by coating at least part of said first deformable and/or said second deformable transparent membrane with an optical transparent material having a different Coefficient of Thermal expansion (CTE) than the one of said first deformable and said second deformable transparent membrane.

2-13. (canceled)

14. The method according to claim 1, wherein said structure located between said first deformable and said second deformable transparent membrane comprises at least one coating located onto all of said first deformable and/or said second deformable transparent membrane.

15. The method according to claim 1, wherein said at least one coating is a film of an optical transparent material having a different CTE than the said first deformable and said second deformable transparent membrane.

16. The method according to claim 15, wherein said at least one coating has a transparency gradient along the radius of said tunable lens.

17. The method according to claim 1, wherein said first deformable and/or second deformable transparent membrane is a plano-convex or plano-concave membrane.

18. The method according to claim 1, wherein said first deformable and/or second deformable transparent membrane has/have a thickness gradient along a radius of said tunable lens.

19. A method for creating a predetermined thermal optical power variation for a tunable lens, which comprises:
a first deformable and a second deformable transparent membrane;
a transparent, deformable, non-fluid body located in between said first deformable and said second deformable transparent membrane, said transparent, deformable, non-fluid body comprising a polymer;
a rigid structure located between said first deformable and said second deformable transparent membrane, which induces a predetermined thermal optical power variation of said tunable lens in a range between +5 diopters and −5 diopters, within a temperature range between −40 to 120 °C, and wherein said polymer is a polymer network of cross-linked or partly cross-linked polymers comprising a miscible oil or combination of oils, thereby compensating thermal defocus without actuators, said method comprising:
depositing the transparent, deformable, non-fluid body onto said first deformable or said second deformable transparent membrane;
providing the rigid structure located between said first deformable and said second deformable transparent membrane by introducing at least one structural element onto, below or within said first deformable and/or said second deformable membrane, said at least one structural element having a different CTE than the one of said first deformable or said second deformable transparent membrane or both. (New) The method according to claim 19, wherein said first deformable and/or second deformable transparent membrane is a plano-convex or plano-concave membrane.

21. The method according to claim 19, wherein said first deformable and/or second deformable transparent membrane has/have a thickness gradient along a radius of said tunable lens.
